(19) United States
(12) Patent Application Publication
(10) Pub. No.: US 2014/0000404 A1
(43) Pub. Date: Jan. 2, 2014

(54) SHIFT LEVER DEVICE

(71) Applicant: Fuji Kiko Co., Ltd., Kosai-shi (JP)

(72) Inventors: Keisuke KINO, Tokyo (JP); Satoshi YUKISHITA, Tokyo (JP)

(21) Appl. No.: 13/929,022

(22) Filed: Jun. 27, 2013

(30) Foreign Application Priority Data
Jun. 28, 2012 (JP) 2012-145646
Feb. 28, 2013 (JP) 2013-038308

(51) Int. Cl. F16H 59/10

(52) U.S. Cl. CPC F16H 59/10
USPC 74/473.31

(57) ABSTRACT

A shift lever device comprises: a case including a check projection, the check projection having a surface curved with respect to an axial direction of a steering column; an operation lever provided swingably to perform upshift and downshift, the operation lever including a switch actuation portion; a support shaft supporting the operation lever swingably to the case; a bias unit configured to bias the operation lever toward a standby position from an operation position; and a switch configured to be turned on or off by the switch actuation portion. The bias unit and the switch actuation portion are arranged in an axial direction of the support shaft. The check projection and the switch are arranged in parts of the case that are opposed to the bias unit and the switch actuation portion, respectively, and arranged in the axial direction of the support shaft.

### CROSS REFERENCE TO RELATED APPLICATIONS

This application claims priority to Japanese Patent Applications Nos. 2012-145646 filed on Jun. 28, 2012, and 2013-038308 filed on Feb. 28, 2013, the entire contents of which are incorporated by references herein.

### BACKGROUND OF THE INVENTION

1. Field of the Invention

The present invention relates to a shift lever device which is used as a paddle shift enabling a driver to shift gears with gripping a steering wheel.

2. Description of the Related Art

Japanese Patent Application Laid-Open Publication No. 2007-226698 (Patent document 1) discloses a shift lever device used as a paddle shift. This shift lever device 101 is disposed in a steering column. The shift lever device 101 includes a pair of operation portions. The operation portions are arranged respectively to the left and right of the steering column so that they are located close to the backside (i.e. the front side with reference to a vehicle) of the steering wheel. One of the operation portions is operated to upshift, and the other of the operation portions is operated to downshift. As shown in FIG. 17, the shift lever device 101 includes a case 102 attached to the steering column, and an operation lever 103 supported swingably in the front and back directions of the steering wheel. Between the operation lever 103 and the case 102, a bias device 108 and checking mechanism 104 are disposed. The bias device 108 biases the operation lever 103 toward a standby position side from an operation portion side. The check mechanism 104 gives a clicking feeling to a driver through the operation lever 103 when the driver operates the operation lever 103. A switch 105 is set on a side surface of the operation lever 103. A connector 106 is set on a side surface of the case 102. In the disclosure of Patent Document 1, the check mechanism 104, switch 105, connector 106 and bias device 108 are arranged in a circumferential direction of an axis of a roll pin 107.

With the above configuration, the shift lever device 101 turns on or off the switch 105 by the driver's swing operation of the operation lever 103, and thus an electric signal is output. Upshift or downshift of a transmission is performed depending on the output electric signal.

### SUMMARY OF THE INVENTION

In the technique disclosed in the Patent Document 1, several parts are arranged in the circumferential direction of the roll pin. Accordingly, a dimension of the shift lever device in a radial direction of the steering wheel becomes large when it is installed in a vehicle.

The object of the present invention is to provide a shift lever device capable of giving a clicking feeling to a driver in a operation thereof without increasing a dimension of the shift lever device in a radial direction of a steering wheel.

An aspect of the present invention is a shift lever device comprising: a case fixed to a steering column located in a back of a steering wheel, the case including a check projection, the check projection having a surface curved with respect to an axial direction of the steering column; an operation lever provided swingably between a standby position and an operation position to perform upshift and downshift, the operation lever including a switch actuation portion; a support shaft supporting the operation lever swingably to the case; a bias unit fixed to the operation lever, configured to bias the operation lever toward the standby position from the operation position; a switch configured to be turned on or off by the switch actuation portion when the operation lever swings toward the operation position; and a check mechanism configured to give a clicking feeling to the operation lever by a slide of the bias unit on the check projection of the case with pressing thereto when the operation lever swings to the operation position; wherein the bias unit and the switch actuation portion are arranged in an axial direction of the support shaft, the check projection and the switch are arranged in parts of the case that are opposed to the bias unit and the switch actuation portion, respectively, and the check projection and the switch are arranged in the axial direction of the support shaft.

The bias unit may include a plate spring formed into a rectangular shape. A longitudinal direction of the bias unit may be perpendicular to the support shaft. One end of the bias unit may be fixed to the operation lever so as to bend in a swing direction of the operation lever. The other end of the bias unit may include a check portion formed protruding toward the check projection. The check projection may be formed on an inner surface of the case along the longitudinal direction of the bias unit.

The operation lever may include a pivot portion into which the support shaft is inserted, and a plate portion formed in the vicinity of the pivot portion and formed extending in the longitudinal direction of the bias unit. The switch actuation portion may include a projection formed at a tip end of the plate portion. The case may include: an insertion opening configured to communicate between an inside of the case and an outside thereof, the insertion opening into which the plate portion and the bias unit are inserted from the outside of the case to the inside thereof; an operation window allowing the switch actuation portion to be exposed swingably in the operation window; and a pin provided at an opening edge of the operation window or in the vicinity thereof, and formed protruding from the case to support the switch.

The shift lever device may further comprise a stopper formed at a part of the plate portion located between the switch actuation portion and the bias unit, the stopper formed protruding toward the check projection from the plate portion, and including a tip end to be contacted with the case when the operation lever positions in the operation position.

The shift lever device may further comprise: a stopper protruding from a tip end of the plate portion along the longitudinal direction of the plate portion; and a regulation portion formed in the case to allow the stopper to move in an inside thereof, and the regulation portion being contacted with the stopper when the operation lever positions in the operation position.

According to the present invention, it is possible to provide a shift lever device capable of giving a clicking feeling to a driver in a operation thereof without increasing a dimension of the shift lever device in a radial direction of a steering wheel.

### BRIEF DESCRIPTION OF THE DRAWINGS

FIG. 1 is an exploded perspective view illustrating a shift lever device according to a first embodiment of the present invention.

FIG. 2 is a side view illustrating a case according to the first embodiment of the present invention.

FIG. 3 is a plan view illustrating the shift lever device according to the first embodiment of the present invention.

FIG. 4 is a sectional view of the shift lever device according to the first embodiment along a IV-V line in FIG. 3, illustrating a state where an operation lever positions in a standby position.

FIG. 5 is a sectional view of the shift lever device according to the first embodiment along a IV-V line in FIG. 3, illustrating a state where the operation lever positions in an operation position.

FIG. 6 is a side view of the shift lever device according to the first embodiment in which the operation lever positions in the standby position.

FIG. 7 is a side view of the shift lever device according to the first embodiment in which the operation lever positions in the operation position.

FIG. 8 is an exploded perspective view illustrating a shift lever device according to a second embodiment of the present invention.

FIG. 9 is an assembly diagram the shift lever device according to the second embodiment viewed from a direction indicated by an arrow in FIG. 8.

FIG. 10 is a side view of the shift lever device according to the second embodiment in which an operation lever positions in a standby position.

FIG. 11 is a side view of the shift lever device according to the second embodiment in which the operation lever positions in an operation position.

FIG. 12 is a side view illustrating the shift lever device according to the second embodiment of the present invention.

FIG. 13 is a sectional view of the shift lever device according to the second embodiment along a XIII-XIII in FIG. 12, illustrating a state where the operation lever positions in the standby position.

FIG. 14 is a sectional view of the shift lever device according to the second embodiment along a XIV-XIV line in FIG. 12, illustrating a state where the operation lever positions in the standby position.

FIG. 15 is a sectional view of the shift lever device according to the second embodiment along the XIII-XIII line in FIG. 12, illustrating a state where the operation lever positions in the operation position.

FIG. 16 is a sectional view of the shift lever device according to the second embodiment along a XIV-XIV line in FIG. 12, illustrating a state where the operation lever positions in the operation position.

FIG. 17 is a perspective view illustrating a conventional shift lever device.

### DESCRIPTION OF THE PREFERRED EMBODIMENTS

Embodiments according to the present invention will be described hereinafter with reference to the drawings.

### First Embodiment

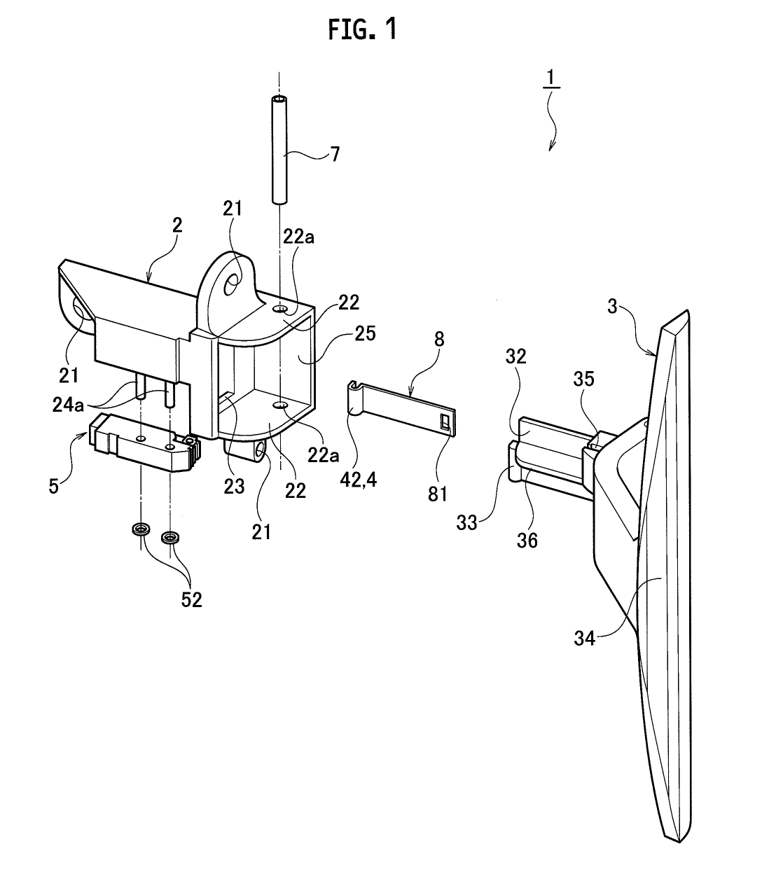

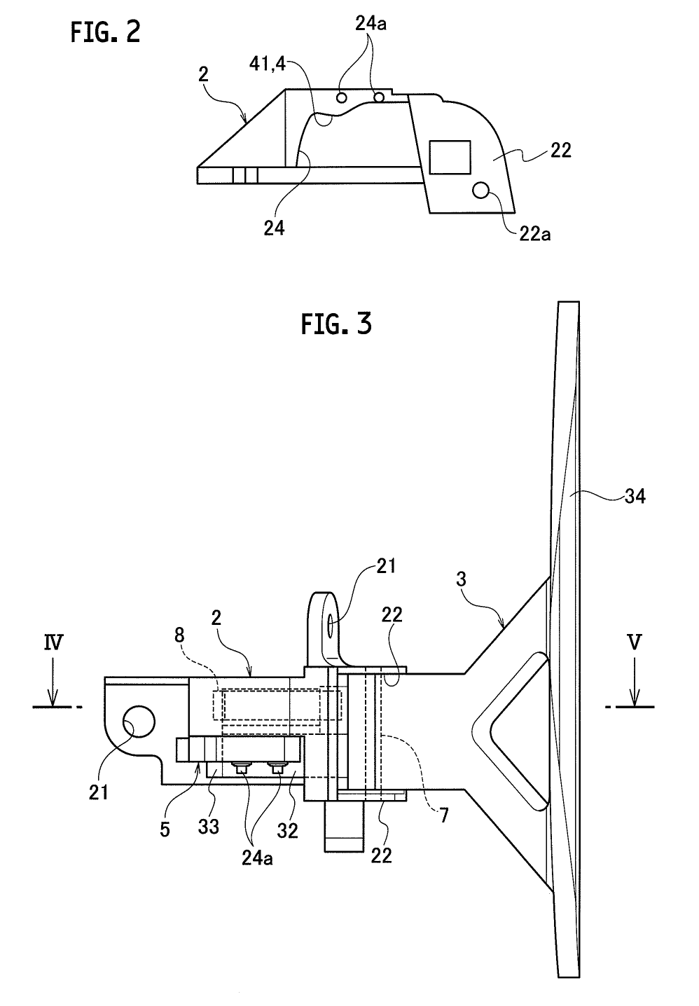

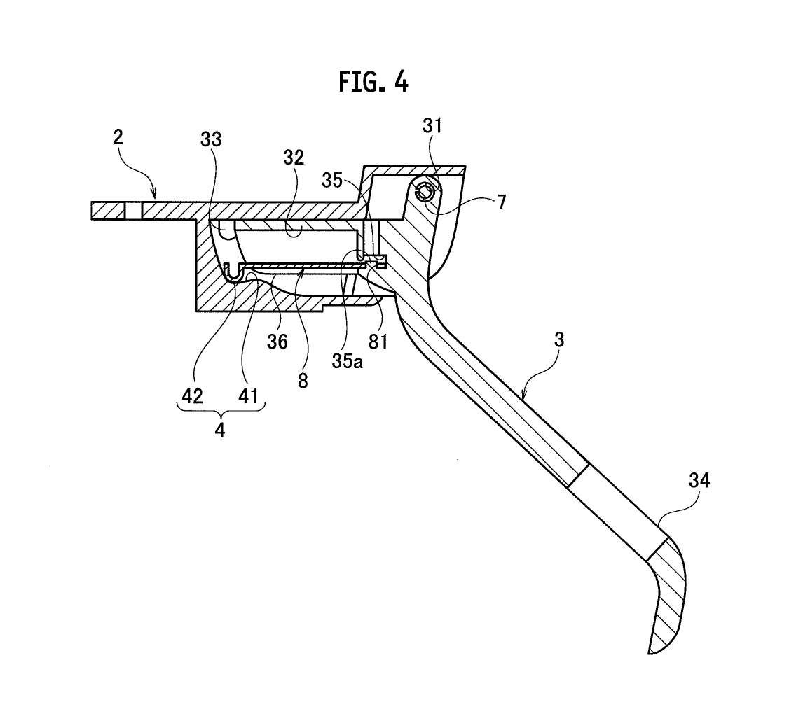

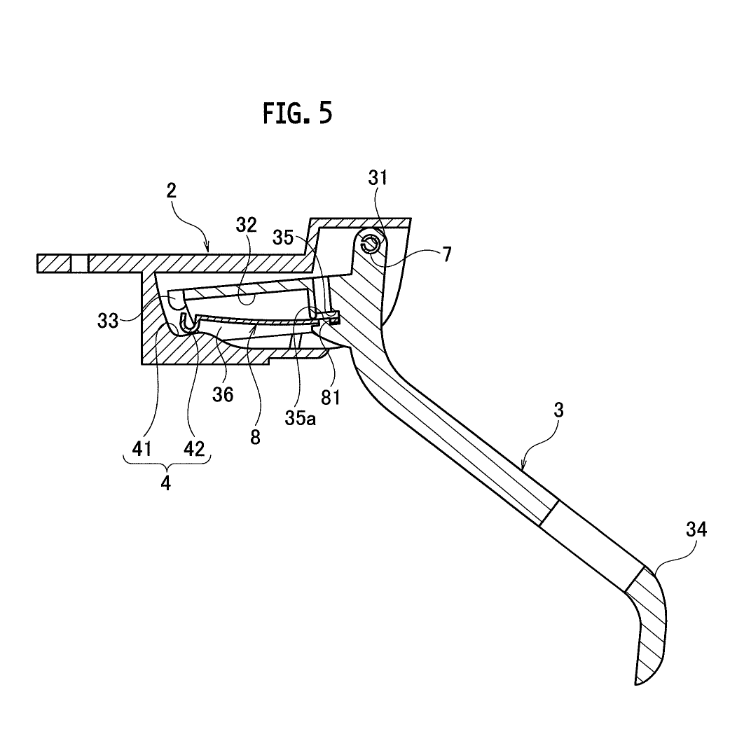

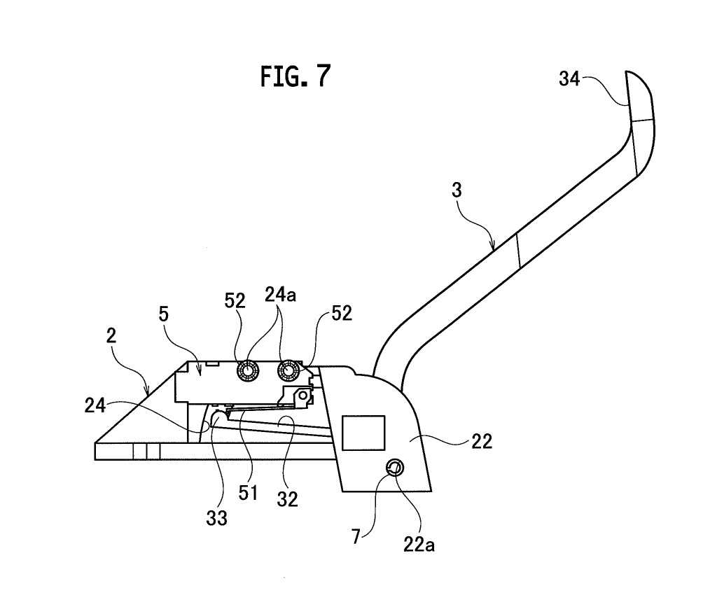

As illustrated in FIGS. 1 to 7, a shift lever device 1A according to the present embodiment is used as a paddle shift enabling a driver to shift gears while gripping a steering wheel. The shift lever device 1A includes: a case 2 fixed to a steering column 92; an operation lever 3 swingably (pivotally) supported to the case 2; a check mechanism giving a clicking feeling to the driver when the operation lever 3 is operated; and a switch 5 turned on or off when the operation lever 3 is operated.

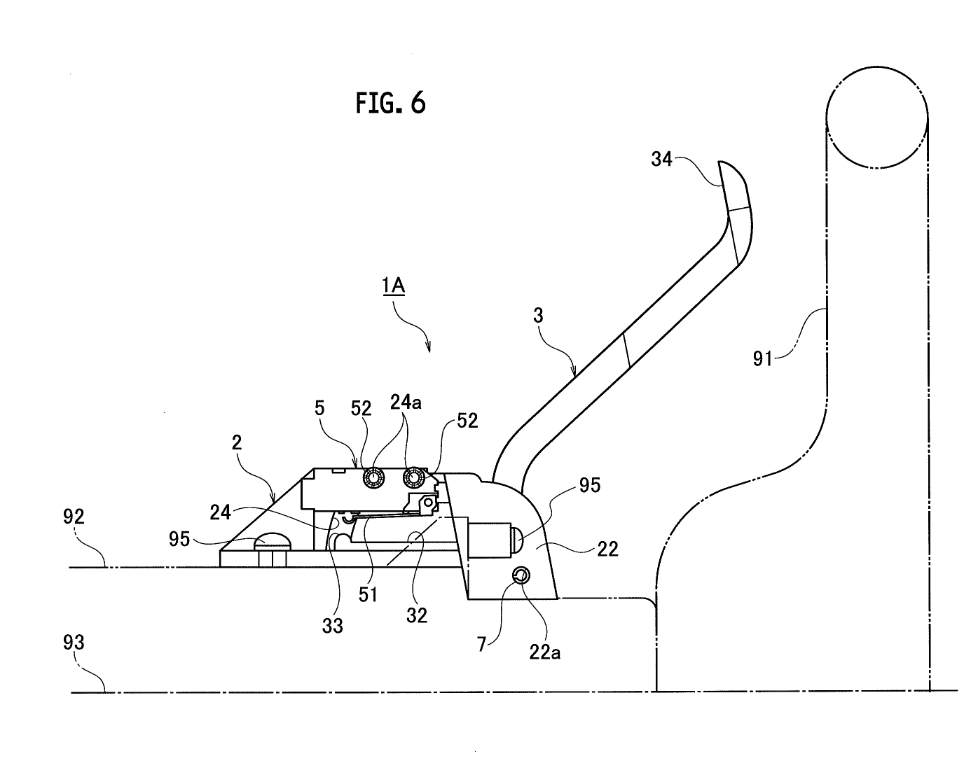

The case 2 has a box-like shape formed into a cuboid. The case 2 includes: fixation portions 21 fixed to the steering column 92; a case-side pivot portion 22 pivotally supporting the operation lever 3; and two openings serves as insertion opening 23 and operation window 24. Three fixation portions 21 are formed in the case 2. The case 2 is fixed to a predetermined position of the steering column 92 using the fixation portions 21 and fixation member such as bolts 95 (see FIG. 6). The case-side pivot portion 22 is formed into two parallel plates formed at the edge of the insertion opening 23. These plates are perpendicular to a flange portion 25 also formed at the edge of the insertion opening 23. Each plate of the case-side pivot portion 22 is provided with a through hole 22a. A support shaft 7 is firmly inserted into through holes 22a of the case-side pivot portion 22 and a lever-side pivot portion 31 of the operation lever 3. The support shaft 7 is composed of a spring pin, for example. The insertion opening 23 opens in an end face of the case 2 toward the longitudinal direction of the case 2. The insertion opening 23 communicates between an inside of the case 2 and an outside thereof. A plate portion 32 and a bias unit 8 (both described later) are inserted from the outside of the case 2 to the inside of the case 2 in a state where the operation lever 3 is pivotally supported. The operation window 24 opens in a face of the case 2 in the longitudinal of the case 2. The operation window 24 opens to allow a switch actuation portion 33 (described later) to be swingably exposed in the operation window 24. A pair of pins 24a is formed at an opening edge of the operation window 24 or in the vicinity thereof. These pins 24a are formed protruding from the case 2 to support a switch 5 by their insertions to the switch 5.

When the shift lever device 1A is attached to the steering column 92, a base end side of the operation lever 3 is pivotally supported to the case 2 on the steering column 92, and a tip end side of the operation lever 3 extends toward the backside (i.e. the front side with reference to the vehicle) of the steering wheel 91. The operation lever 3 includes an operation portion 34 on the tip end side thereof. The operation portion 34 is formed into a sector shape corresponding to a shape of the steering wheel 91. The operation lever 3 includes the lever-side pivot portion 31 on the base end side thereof. The lever-side pivot portion 31 enables the operation lever 3 to swing in cooperation with the case-side pivot portion 22. The lever-side pivot portion 31 is provided with an insertion hole into which the support shaft 7 is inserted. Here, the support shaft 7 is supported to the case 2. The operation lever 3 includes a spring-receiving portion 35 formed in the vicinity of the lever-side pivot portion 31 on the operation portion 34 side. The spring-receiving portion 35 is formed into a groove (recess) extending perpendicularly to the support shaft 7.

A bias unit 8 is set to the spring-receiving portion 35. The bias unit 8 is composed of a plate spring formed into a rectangular shape. A longitudinal direction of the bias unit 8 is perpendicular to the support shaft 7. An end of the bias unit 8 is fixed to the operation lever 3 so as to bend in a swing direction of the operation lever 3. A base end of the bias unit 8 is provided with an engagement hole 81. The engagement hole 81 is formed into a rectangular through hole penetrating through flat surfaces of the bias unit 8. On the other hand, an engagement projection 35a is formed in the spring-receiving portion 35. The engagement projection 35a protrudes from an inner surface of the spring-receiving portion 35. Therefore, the engagement projection 35a is engaged with the engagement hole 81, thereby the bias unit 8 is fixed to the spring-receiving portion 35. A check portion 42 is formed at a tip end of the bias unit 8. The check portion 42 protrudes toward a check projection 41 (described later).

A plate portion 32 is formed between the spring-receiving portion 35 and the lever-side pivot portion 31 of the operation lever 3. The plate portion 32 has a shape formed into a flat plate. The plate portion 32 extends from the operation lever 3 along the longitudinal direction of the bias unit 8 and parallel with the flat surfaces of the bias unit 8. The switch actuation portion 33 is formed at the tip end of the plate portion 32. The switch actuation portion 33 includes a projection formed into a hemispherical dome. The switch actuation portion 33 protrudes toward the switch 5 adjacent to the check projection 41. The operation lever 3 includes a stopper 36 disposed at a part of the plate portion 32 located between the switch actuation portion 33 and the bias unit 8. The stopper 36 protrudes toward the check projection 41 from the plate portion 32.

The check mechanism 4 includes a check portion 42 formed in the bias unit 8 and the check projection 41 formed on an inner surface of the case 2. The check projection 41 is provided in a part of the case 2 which is opposed to the bias unit 8. The check projection 41 protrudes from an inner surface of the case 2 so as to make the inner surface uneven toward the longitudinal direction of the bias unit 8. In other words, the check projection 41 has a surface curved with respect to an extending direction of an axis 93 of the steering column 92 (i.e. an axial direction of the steering column 92).

The switch 5 is used generally to make or break electronic circuit. In the present embodiment, a micro switch is used as the switch 5. The micro switch has contacts (not shown) that contact with one another to provide a conductive condition of the electronic circuit only when an ON operation is performed thereto. The switch 5 is supported to the case 2 by the pins 24a so that a switch lever 51 of the switch 5 faces toward the standby position of the operation lever 3 from the operation position thereof. Specifically, the switch 5 is arranged so that the switch lever 51 thereof is opposed to the switch actuation portion 33. For example, as shown in FIG. 6, the switch lever 51 is disposed so that a longitudinal direction of the switch lever 51 aligned in the axial direction of the steering column 92. The switch 5 includes a body formed into a flat cuboid shape. This body is disposed so that a longitudinal direction of the body is disposed so that a longitudinal direction of the body is aligned to the axial direction of the steering column 92. Further, the switch 5 and the check projection 41 are arranged in the axial direction of the support shaft 7. In other words, they are disposed in series in the axial direction of the support shaft 7. Here, as described above, a curved surface of the check projection 41 is curved with respect to the axial direction of the steering column 92. A push nut 52 is attached to the tip end of each pin 24a, thereby the switch 5 is fixed to the case 2.

Next, assembling procedures of the shift lever device according to the present embodiment will be described. Firstly, the based end of the bias unit 8 is inserted into the spring-receiving portion 35 to engage the engagement hole 81 with the engagement projection 35a, thereby the bias unit 8 is attached to the operation lever 3. Next, the switch 5 is set to the pins 24a, and the push nuts 52 are attached to the tip ends of the pins 24a to fix the switch 5 to the case 2. Next, the plate portion 32 of the operation lever 3 and the bias unit 8 are inserted into the insertion opening 23 of the case 2. Finally, the support shaft 7 is inserted into the through holes 22a of the case-side pivot portion 22 and the through hole of the lever-side pivot portion 31 positioned between the through holes 22a, thereby the operation lever 3 is pivotally supported to the case 2.

When the operation lever 3 is set to the case 2, the check portion 42 is constantly biased to the check projection 41 by the bias unit 8. In addition, the plate portion 32 contacts with the inner surface of the case 2 by a recovery force of the bias unit 8, which is generated from the biasing of the bias unit 8. Accordingly, the operation lever 3 is biased and held in the standby position. While the operation lever 3 swings from the standby position to the operation position, the check portion 42 of the bias unit 8 slides on the check projection 41 of the case 2, and the switch actuation portion 33 turns on the switch 5. In this operation, the degrees of bending of the bias unit 8 vary depending on the shape (i.e. curved surface) of the check projection 41, and the generated recovery force gives a clicking feeling to the driver. When the operation lever 3 is further operated after the switch 5 is already turned on, the tip end of the stopper 36 contacts with the check projection 41 to protect the switch 5. When the driver eases a force for the operation of the operation lever 3, the operation lever 3 returns from the operation position to the standby position by the recovery force of the bias unit 8, and the plate portion 32 contacts with the inner surface of the case 2, thereby the operation lever 3 is held in the standby position with being biased thereto.

In the present embodiment, as shown in FIGS. 3 and 6, the bias unit 8 and the switch actuation portion 33 are arranged in the axial direction of the support shaft 7. Accordingly, these parts does not have to be arranged in the circumferential direction of the support shaft as seen in the conventional shift lever device. Thus, it is possible to reduce the dimension of the shift lever device in the radial direction of the steering wheel when installed in the vehicle. In addition, the bias unit 8, the support shaft 7, the case 2, and the switch 5 according to the present embodiment can be commonly used in the shift lever device 1A installed on the left and right sides. Therefore, it is possible to reduce the manufacturing cost of the shift lever device.

Further, a plate spring is used as the bias unit 8. Therefore, it is possible to reduce the dimension of the shift lever device in the radial direction thereof when installed in the vehicle, and the configuration of the check mechanism 4 can be simplified and miniaturized. Consequently, it is possible to compactly arrange the shift lever device 1A on the side of the steering column.

Since the stopper 36 is disposed at the part of the plate portion 32 between the switch actuation portion 33 and the bias unit 8, it is not required to arrange the stopper 36 in other positions. Therefore, this can reduce the number of the parts for the shift lever device and miniaturize it.

The switch 5 is supported to the case 2 by the pins 24a provided at or in the vicinity of the opening edge of the operation window 24 in a protruding manner. Therefore, the case 2 can be miniaturized, and one of widely used switches can be applied as the switch 5. Accordingly, it is possible to reduce the manufacturing cost of the shift lever device.

The members provided at the opening edge of the operation window 24 arrange the switch 5 to the case 2. Therefore, even when the micro switch is changed from the one supported by the pins to the other supported by any members except of the pins, it is easy to change the shape of the case 2, and thus it is possible to apply a switch more appropriately to a design condition.

### Second Embodiment

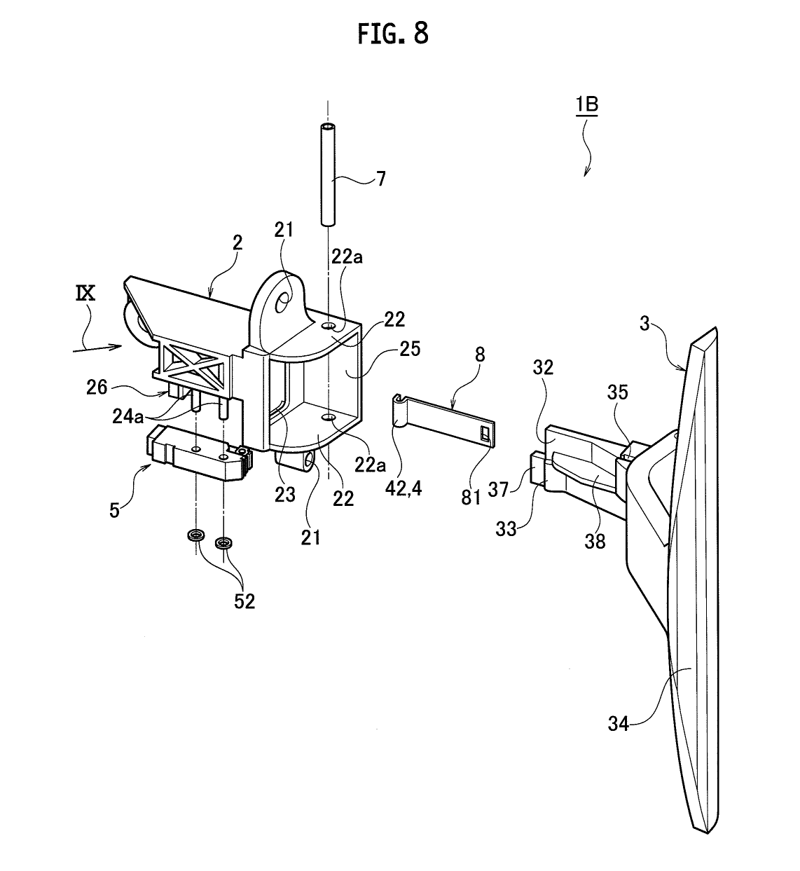

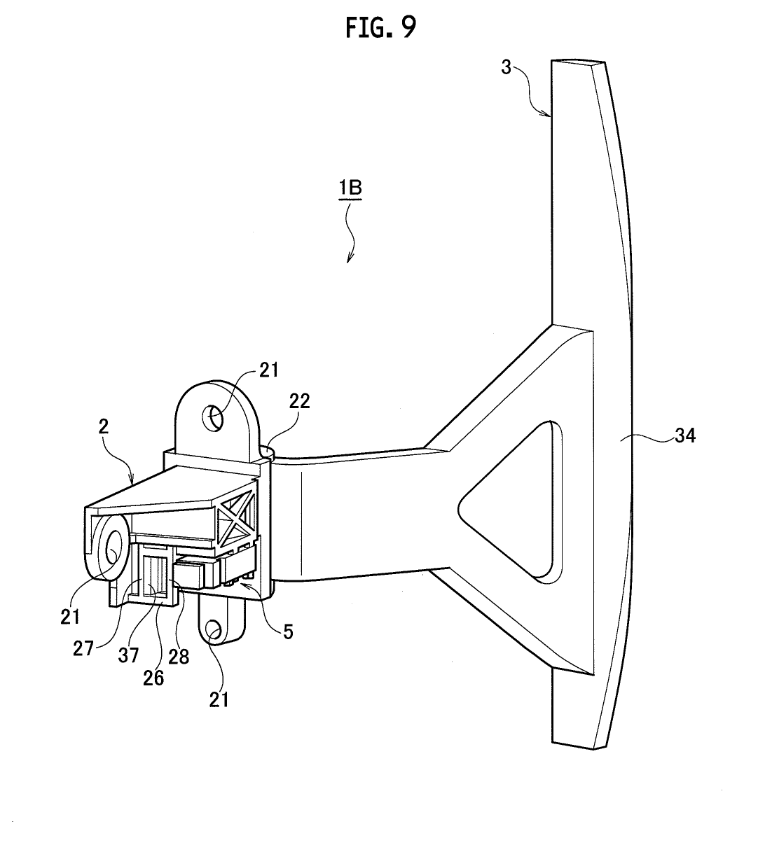

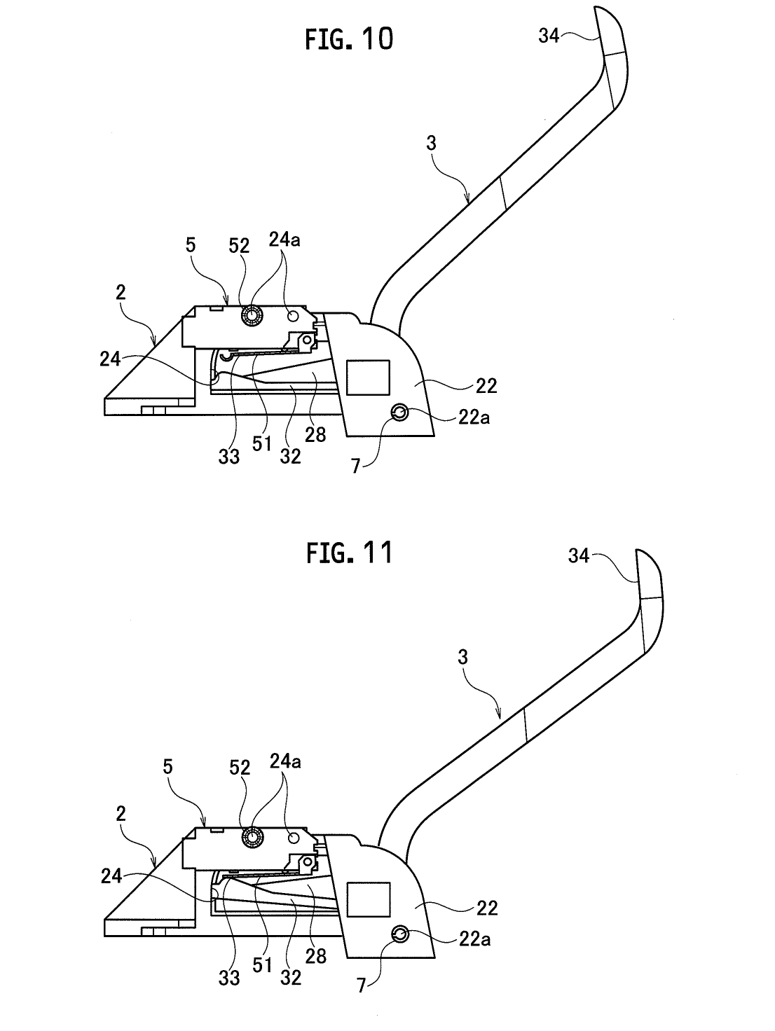

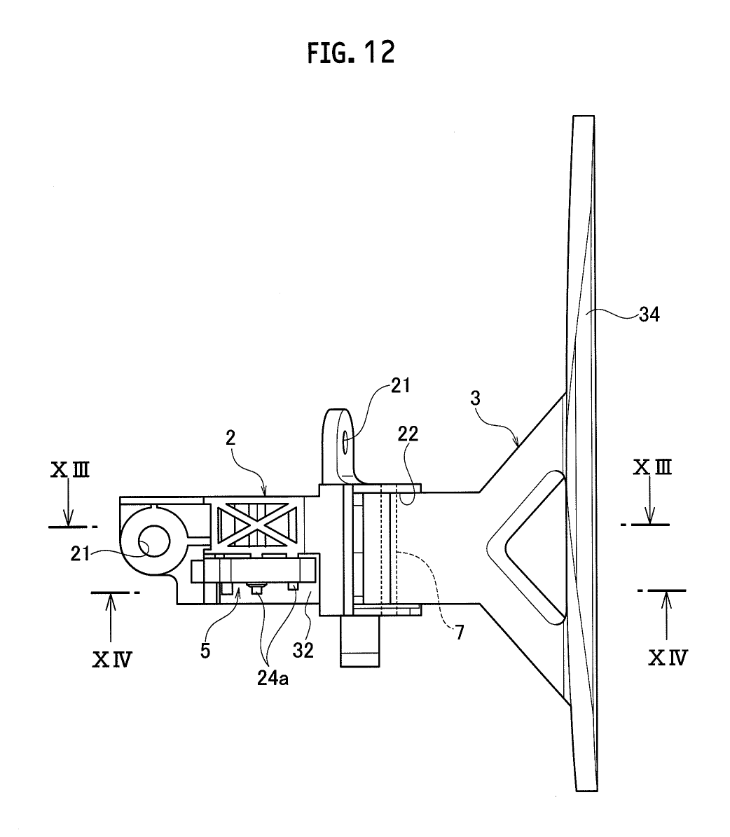

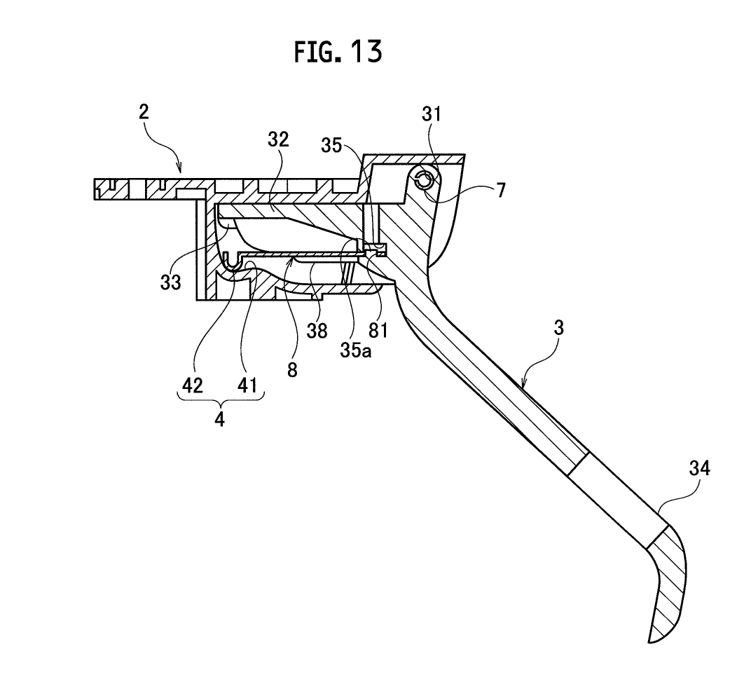

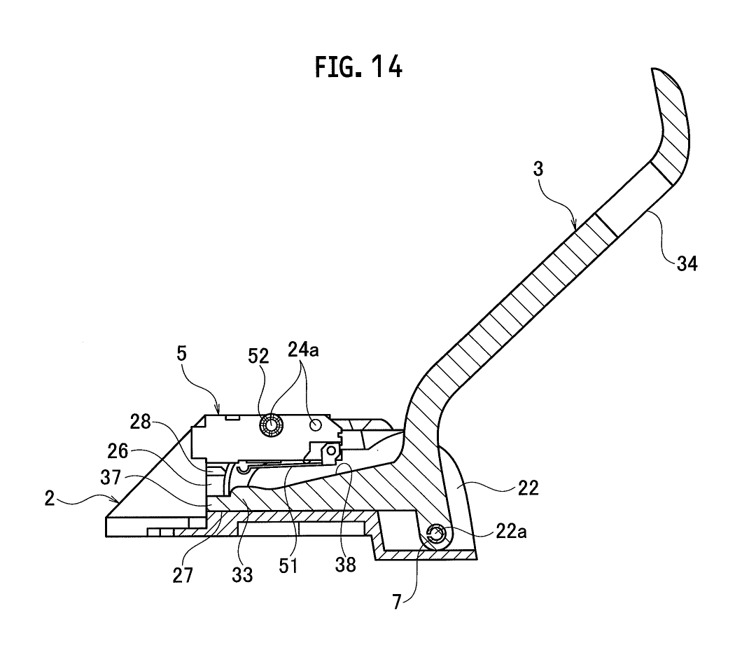

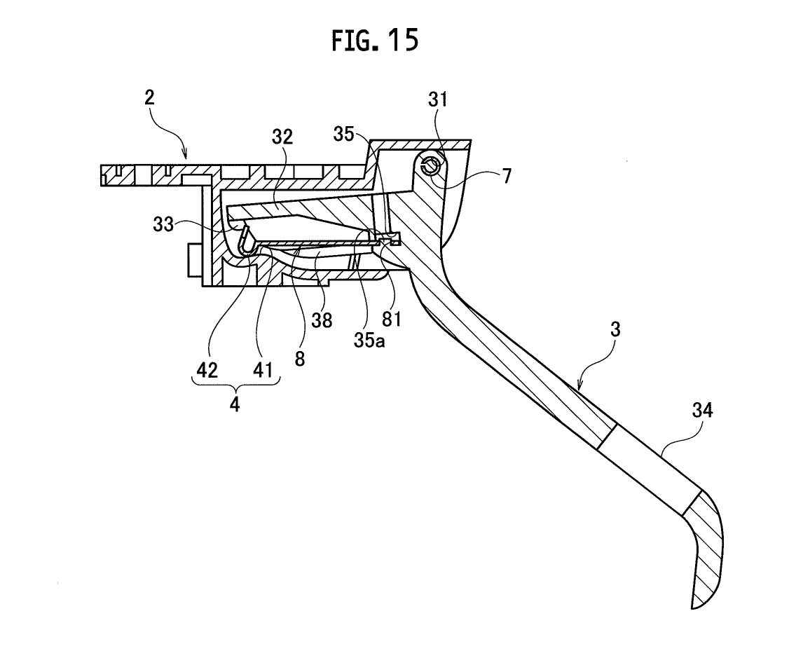

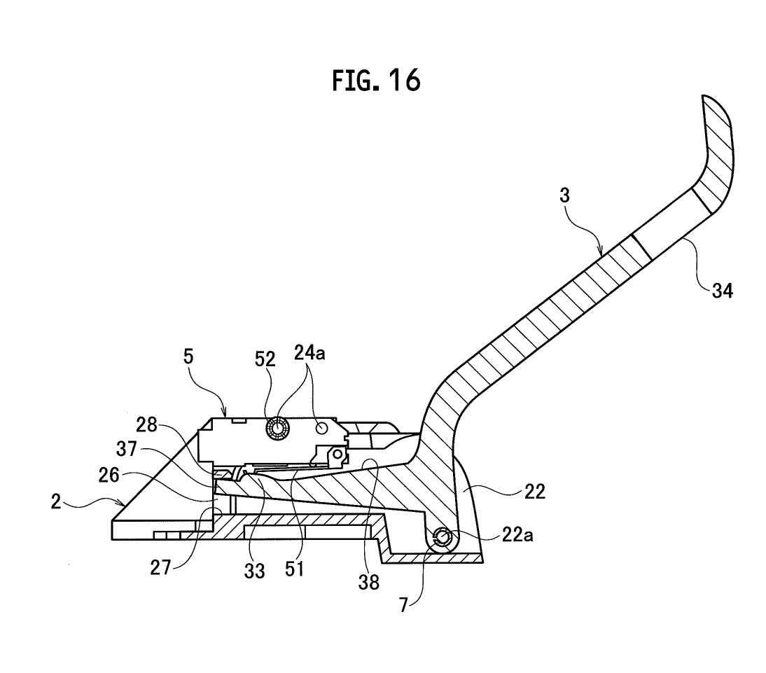

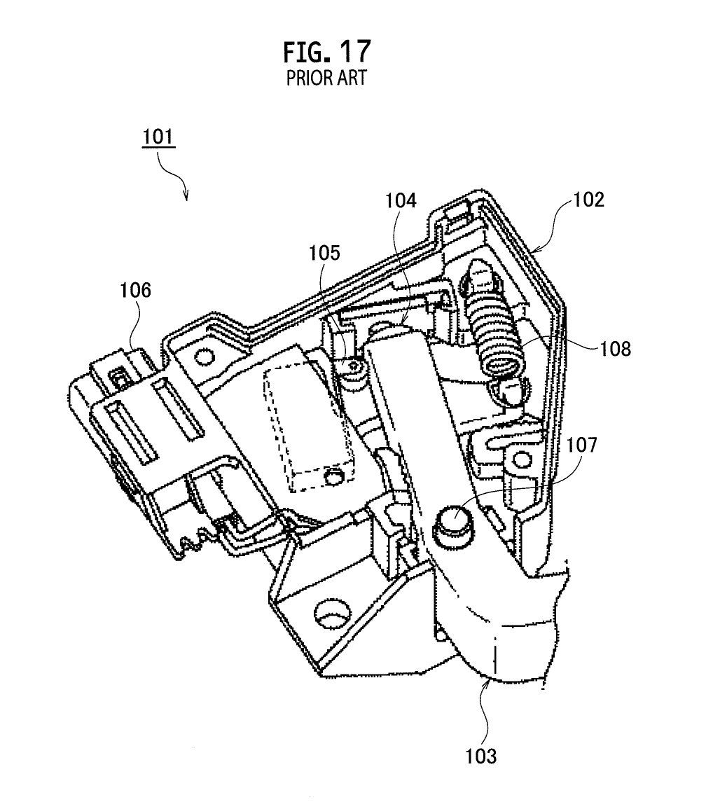

FIGS. 8 to 16 show a shift lever device according to a second embodiment of the present invention. The shift lever device according to the second embodiment differs from the one according to the first embodiment by the followings. The stopper 37 is located in a position of the operation lever 3 which is spatially different from the position in the first embodiment. A regulation portion 26 is arranged in the case 2. Finally, a rib 38 is provided. The rib 38 protrudes toward the check projection 41 from the part of the plate portion 32 at which the stopper 36 is disposed in the first embodiment; in other words, it protrudes from the part of the plate portion 32 between the switch actuation portion 33 and the bias unit 8. Meanwhile, the components shown in FIGS. 8 to 16, which are same as those shown in FIGS. 1 to 7, are indicated by the same references in FIGS. 1 to 7, and thus their explanations are omitted.

The stopper 37 is formed at the tip end of the switch actuation portion 33. The stopper 37 protrudes from the tip end in the longitudinal direction of the plate portion 32. The regulation portion 26 is formed into a rectangular frame which opens at the other end surface of the case 2 in the longitudinal direction of the case 2. The regulation portion 26 is formed to allow the stopper to move therein. The regulation portion 26 includes a standby-side regulation portion 27 on its standby position side (a left side in FIG. 9). The regulation portion 26 includes an operation-side regulation portion 28 on its operation position side (a right side in FIG. 9). The operation lever 3 contacts with the standby-side regulation portion 27 when it is located in the standby position. Alternatively, the operation lever 3 contacts with the operation-side regulation portion 28 when it is located in the operation position.

In assembling of the shift lever device according to the present embodiment, the plate portion 32 and the bias unit 8 are inserted into the insertion opening 23 of the case 2 and pushed toward a tip end side of the case 2. Thereafter, the stopper 37 formed at the tip end of the operation lever 3 is inserted into the frame of the regulation portion 26. Next, the support shaft 7 is inserted into the through holes 22a of the case-side pivot portion 22 and the lever-side pivot portion 31 to pivotally support the operation lever 3 to the case 2.

When the operation lever 3 is attached to the case 2, the check portion 42 is biased to the check projection 41 by the bias unit 8, and the stopper 37 at the tip end of the plate portion 32 contact with the standby-side regulation portion 2 of the case 2 by the recovery force of the bias unit 8, thereby the operation lever 3 is held in the standby position with being biased.

When the operation lever 3 swings from the standby position to the operation position, the check portion 42 slides on the check projection 41, and the switch actuation portion 33 turns on the switch 5. When the operation lever 3 is further operated after the switch 5 is already turned on, the stopper 37 at the tip end of the plate portion 32 contacts with the operation-side regulation portion 28 of the case 2, and thus the swing motion of the operation lever 3 is restricted. Therefore, the operation lever 3 is held in the operation position with being biased, and the switch 5 is protected. In the above operation, the stopper 37 contacts with the operation-side regulation portion 28. However, a tip end of the rib 38 does not contact with the check projection 41.

When the driver eases a force for the operation of the operation lever 3, the operation lever 3 returns from the operation position to the standby position by the recovery force of the bias unit 8, and the stopper 37 at the tip end of the plate portion 32 contacts with the standby-side regulation portion 27 of the case 2, thereby the operation lever 3 is held in the standby position with being biased. In the above operation, the stopper 37 contacts with the standby-side regulation portion 27. However, the plate portion 32 does not contact with the inner surface of the case 2.

The second embodiment as described above can provide the same operations and advantageous effects as those of the first embodiment.

Further, in the second embodiment, the stopper 37 is formed at the tip end of the plate portion 32 in a protruding manner, and the regulation portion 26 is formed so as to allow the stopper 37 to move in the inside of the regulation portion 26. Therefore, the stopper 37 and the regulation portion 26 are arranged far away from the support shaft 7 in the radial direction of the support shaft 7, and a position to restrict the swing motion of the operation lever 3 can be set accurately. Specifically, when a part of the operation lever 3 is farther from the support shaft 7 in the radial direction thereof, the moving distance of the part accompanied with the swing of the operation lever 3 becomes longer. This means that a variation of a moving distance of the switch actuation portion 33 becomes large due to the dimensional tolerances of the stopper and the regulation portion if they are located in the vicinity of the support shaft, and that this reduces an accuracy of the position for restricting the swing motion of the operation lever 3. In the present embodiment, however, the stopper 37 is arranged at the tip end of the plate portion 32 which positions far away from the support shaft 7 in the radial direction thereof, and the regulation portion 26 is arranged in a position far away from the support shaft 7 in the radial direction thereof. Accordingly, it is possible to securely operate the switch 5 without applying an excessive load to the switch 5 when the operation lever 3 positions in the operation position. In addition, the switch 5 can be securely protected when the operation lever 3 positions in the standby position.

In the present embodiment, the regulation portion 26 is formed into a rectangular frame. However, the shape of regulation portion 26 is not limited to this shape. For example, the regulation portion 26 may be formed into a box shape in which the stopper can be movable. In this case, the aforementioned operations and effects are obtained.

What is claimed is:

1. A shift lever device comprising:
a case fixed to a steering column located in a back of a steering wheel, the case including a check projection, the check projection having a surface curved with respect to an axial direction of the steering column;
an operation lever provided swingably between a standby position and an operation position to perform upshift and downshift, the operation lever including a switch actuation portion;
a support shaft supporting the operation lever swingably to the case;
a bias unit fixed to the operation lever, configured to bias the operation lever toward the standby position from the operation position;
a switch configured to be turned on or off by the switch actuation portion when the operation lever swings toward the operation position; and
a check mechanism configured to give a clicking feeling to the operation lever by a slide of the bias unit on the check projection of the case with pressing thereto when the operation lever swings to the operation position;
wherein the bias unit and the switch actuation portion are arranged in an axial direction of the support shaft,
the check projection and the switch are arranged in parts of the case that are opposed to the bias unit and the switch actuation portion, respectively, and
the check projection and the switch are arranged in the axial direction of the support shaft.

2. The shift lever device according to claim 1, wherein
the bias unit includes a plate spring formed into a rectangular shape,
a longitudinal direction of the bias unit is perpendicular to the support shaft,
one end of the bias unit is fixed to the operation lever so as to bend in a swing direction of the operation lever,
the other end of the bias unit includes a check portion formed protruding toward the check projection,
the check projection is formed on an inner surface of the case along the longitudinal direction of the bias unit.

3. The shift lever device according to claim 1, wherein
the operation lever includes a pivot portion into which the support shaft is inserted, and a plate portion formed in the vicinity of the pivot portion and formed extending in the longitudinal direction of the bias unit,
the switch actuation portion includes a projection formed at a tip end of the plate portion,
the case includes: an insertion opening configured to communicate between an inside of the case and an outside thereof, the insertion opening into which the plate portion and the bias unit are inserted from the outside of the case to the inside thereof; an operation window allowing the switch actuation portion to be exposed swingably in the operation window; and a pin provided at an opening edge of the operation window or in the vicinity thereof, and formed protruding from the case to support the switch.

4. The shift lever device according to claim 1, further comprising
a stopper formed at a part of the plate portion located between the switch actuation portion and the bias unit, the stopper formed protruding toward the check projection from the plate portion, and including a tip end to be contacted with the case when the operation lever positions in the operation position.

5. The shift lever device according to claim 1, further comprising:
a stopper protruding from a tip end of the plate portion along the longitudinal direction of the plate portion; and
a regulation portion formed in the case to allow the stopper to move in an inside thereof, and the regulation portion being contacted with the stopper when the operation lever positions in the operation position.
